(19) United States
(12) Patent Application Publication
(10) Pub. No.: US 2013/0067008 A1
(43) Pub. Date: Mar. 14, 2013

(54) Method and Apparatus for Establishing Independent Message Page

(71) Applicant: Tencent Technology (Shenzhen) Company Limited, Shenzhen (CN)

(72) Inventor: Yu Ku, Shenzhen (CN)

(73) Assignee: TENCENT TECHNOLOGY (SHENZHEN) COMPANY LIMITED, Shenzhen (CN)

(21) Appl. No.: 13/672,058

(22) Filed: Nov. 8, 2012

Related U.S. Application Data
(63) Continuation of application No. PCT/CN2011/071421, filed on Mar. 1, 2011.

(30) Foreign Application Priority Data
Jun. 24, 2010 (CN) 201010208517.1

(51) Int. Cl. G06F 15/16

(52) U.S. Cl. 709/206

(57) ABSTRACT

A method for establishing an independent message page is provided. The method includes: obtaining, by an IM client, a trigger event for a message in a main panel, and obtaining identification information of the message according to the trigger event; determining, by the IM client, an independent message page corresponding to the identification information of the message; displaying, by the IM client, the independent message page. By using the present invention, the usability and interactivity of the IM client are improved. An apparatus applying the above method is also provided.

### CROSS-REFERENCE TO RELATED APPLICATIONS

This application is a continuation of International Application No. PCT/CN2011/071421, filed on Mar. 1, 2011. This application claims the benefit and priority of Chinese Patent Application No. 201010208517.1, filed Jun. 24, 2010. The entire disclosures of each of the above applications are incorporated herein by reference.

### FIELD OF THE INVENTION

The present invention relates to Internet technologies, and more particularly to a method and apparatus for establishing an independent message page.

### BACKGROUND OF THE INVENTION

With the developments of network technologies and the expansion of the impacts of the network, Instant Messaging (IM) tools have been accepted by most Internet users and have become essential software tools of the Internet users. The IM tools are widely used in the entertainment and normal work. Hence, the users have high requirements for the IM tools about the usability, stability and security.

In the procedure of using the IM tool, the IM tool may be combined with a micro-blog tool. Micro-blog messages are displayed on a main panel of an IM client chronologically. Specifically, all of the micro-blog messages may be checked via tab pages on the main panel, and the tab page includes a home page, a @ page (i.e. a replay page) and a guest page etc.

By using the micro-blog tool, the user may select to receive the micro-blog messages published by another user and become an audience of the another user, and the user may also have audiences receiving the micro-blog message published by the user. By using the home page, the user receives the micro-blog message published by other users, checks the micro-blog message published by the user, checks comments corresponding to the micro-blog messages, and performs other operations related to the micro-blog messages. By using the @ page, the user checks all of micro-blog messages in which the user is mentioned. By using the guest page corresponding to a certain audience, the user checks all of micro-blog messages published by the audience.

In the procedure of implementing the present invention, shortcomings of conventional modes are found.

When the number of the micro-blog messages received by the user is too large, it is difficult to display all of the micro-blog messages because of the limited space on the main panel of the IM client for displaying the micro-blog messages, and thus when a single micro-blog message is displayed, details of the single micro-blog message can not be displayed clearly and completely.

### SUMMARY OF THE INVENTION

The present invention provides a method and apparatus for establishing an independent message page to improve usability and interactivity of the IM client.

The present invention provides a method for establishing an independent message page, which includes:

obtaining, by an IM client, a trigger event for a message in a main panel, and obtaining identification information of the message according to the trigger event;

determining, by the IM client, an independent message page corresponding to the identification information of the message;

displaying, by the IM client, the independent message page.

The present invention also provides an apparatus for establishing an independent message page, which includes:

an obtaining module, adapted to obtain a trigger event for a message in a main panel, and obtain identification information of the message according to the trigger event;

an establishing module, adapted to determine an independent message page corresponding to the identification information of the message obtained by the obtaining module;

a displaying module, adapted to display the independent message page established by the establishing module.

By using the solutions of the present invention, technical effects are obtained. In the embodiments of the present invention, the independent message page is established and displayed for the message according to the trigger event for the message in the main panel, and the entrance for the independent message page corresponding to the message in the main panel is provided, and thus the displayed contents of the message is greatly increased, and the usability and interactivity of the IM client are improved.

### BRIEF DESCRIPTION OF THE DRAWINGS

In order to make the technical solution of the present invention or prior art clearer, accompanying drawings used in embodiments of the present invention or prior art will be illustrated simply hereinafter. Obviously, the described accompanying drawings are only preferred embodiments of the present invention. Those skilled in the art may obtain other accompanying drawings according to these accompanying drawings without inventive labor.

FIG. 1 is a flowchart illustrating a method for establishing an independent message page according to an embodiment one of the present invention.

FIG. 2 is a schematic diagram illustrating an independent message page in an application scenario according to an embodiment of the present invention.

FIG. 3 is a schematic diagram illustrating an apparatus for establishing an independent message page according to an embodiment of the present invention.

FIG. 4 is a schematic diagram illustrating an apparatus for establishing an independent message page in an application scenario according to an embodiment of the present invention.

### DETAILED DESCRIPTION OF THE INVENTION

In the technical solutions of the present invention, when an IM client is combined with a micro-blog client, an independent message page of the micro-blog is implemented in the IM client, so that a user can enter an independent message page corresponding to a micro-blog message by triggering a message body displaying the micro-blog message in the main panel of the IM client. In the independent message page, if the micro-blog message includes multimedia information, e.g. a picture, an audio or a video, a thumbnail of the multimedia information is displayed, e.g. a thumbnail of the picture or video is displayed and various operations, e.g. a copying operation and an opening operation can be performed. If the micro-blog message is a dialog message, e.g. the micro-blog message relates to a dialog between users, original texts of the dialog are displayed and contents of the whole dialog may be checked based on the original texts. If the micro-blog message is a forwarding message, e.g. the micro-blog message is published by another user and forwarded by this user, when the times of forwarding an original message corresponding to the forwarding message exceeds a preset value, e.g. 10 times, the times of forwarding the original message is displayed. In addition, the independent message page may also display a detailed message source, a specific terminal sending the message and provide descriptions of the specific terminal.

The technical solutions of the present invention will be illustrated in detail hereinafter with reference to the accompanying drawings. Obviously, the described embodiments are only parts of the embodiments of the present invention. Other embodiments obtained by those skilled in the art without inventive labor are all belong to the protection scope of the present invention.

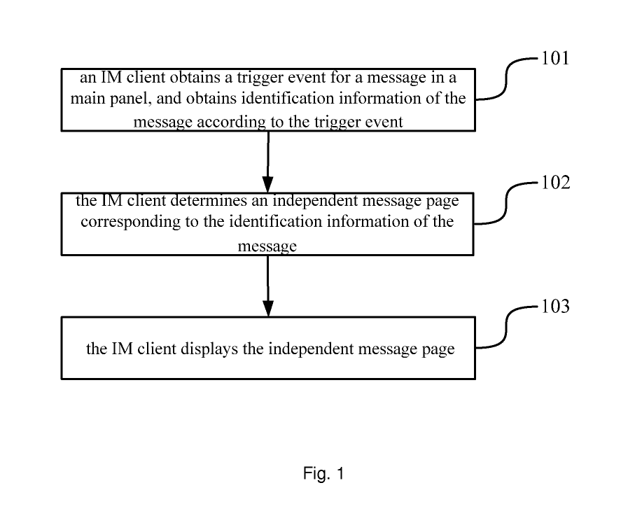

FIG. 1 is a flowchart illustrating a method for establishing an independent message page according to an embodiment one of the present invention. As shown in FIG. 1, the method includes the following operations.

In block 101, an IM client obtains a trigger event for a message in a main panel, and obtains identification information of the message according to the trigger event.

The trigger event may be a mouse click event which includes a mouse double-click event. The IM client monitors the double-click event in a message body area of the main panel. When a user double-clicks the message body area, the IM client obtains the double-click event, obtains a key value of a message corresponding to the double-click event according to a location of the double-clicked message body, takes the key value as the identification information of the message, notifies a control management center of the IM client to establish an independent message page, i.e. sends a request for establishing an independent message page, and transmits parameters to the control management center, the parameters includes data needed for establishing the independent message page.

In block 102, the IM client determines an independent message page corresponding to the identification information of the message.

Specifically, the control management center of the IM client determines whether to establish the independent message page according to a service logic. The service logic may be a displaying logic of the independent message page, for example, displaying the independent message page after a double-click operation or displaying the independent message page by clicking an option in a right click menu.

For one user, because there is only one instance for the home page, the @ page and the independent message page globally, each of the home page, the @ page and the independent message page has only one page, and each audience of the user corresponding to one client page. After the control management center receives the request for establishing the independent message page, if the request includes the identification information of the message, the control management center determines whether the independent message page corresponding to the identification information has been established. If the independent message page corresponding to the identification information has been established, the IM client directly determines the independent message page corresponding to the identification information of the message; if the independent message page corresponding to the identification information has not been established, the IM client establishes the independent message page corresponding to the identification information of the message.

In the embodiments of the present invention, when establishing the independent message page corresponding to the identification information, in one case, when no independent message page has been established, an independent message page is established, and contents of the independent message page correspond to the identification information; in the other case, when contents of an established independent message page do not correspond to the identification information, the established independent message page is updated, so as to make the contents of the independent message page correspond to the identification information.

When the independent message page is established, globally unique information of the independent message page may be stored by a DataService variable, so that the IM client just needs to establish the independent message page once, and the independent message page is globally unique. After the independent message page has been established, for contents of a message corresponding to the same key value, the IM client does not need to change the independent message page. For contents of a message corresponding to a different key value, the IM client establishes the independent message page corresponding to different key value by reassigning each part of the established independent message page, so that the contents of the message corresponding to the different key value is displayed on the same independent message page without reestablishing the independent message page, thereby improving the work performance of the IM client. The independent message page includes at least one of the following content display areas: a sender information area, a sender message display area, a message source display area and a specific information display area.

In block 103, the IM client displays the independent message page.

Because there is only one global visible page, when one of the home page, the @ page and the independent message page is displayed, other pages are hidden.

In the embodiments of the present invention, when the message corresponding to the trigger event is a forwarding message or a dialog message, the IM client displays a message source display area by using the independent message page, and the displaying logic of the message source display area is the same as that of the sender message display area. When the message corresponding to the trigger event is a message of other types, the message source display area is hidden.

In addition, in the independent message page, operations performed by using the mouse right key are supported in the sender message display area and the message source display area. Specifically, because the independent message page belongs to one kind of controls, and a mouse right click event can be monitored in a control layer. When the mouse right click event happens, it is determined whether a location of a mouse is in the sender message display area or the message source display area, if the location of the mouse is in the sender message display area or the message source display area, it is further determined whether the location of the mouse is in a picture preview area. If the location of the mouse is in the picture preview area, the IM client responses the mouse right click event with a picture right click menu; otherwise, the IM client responses with a message body right click menu. The picture right click menu and the message body right click menu may be different or not.

In the block 102, when the independent message page includes the sender information area, the IM client obtains User Identification Number (UIN) of a sender of the message from a message information center located in the IM client according to the identification information of the message, obtains a head portrait picture of the sender of the message according to the UIN, and obtains authentication information of the sender of the message from an authentication server according to the UIN; the authentication information includes a nickname and a micro-blog website etc. The IM client displays the obtained head portrait picture and authentication information in the sender information display area. The IM client monitors the mouse click event for the head portrait picture, the mouse click event for the authentication picture or the micro-blog website of the authentication information. When the mouse click event happens, the IM client determines a jump address according to an identification field of the mouse click event, and jumps to a page corresponding to the address.

When the independent message page includes the sender message display area, the IM obtains contents and a type of the message according to the identification information of the message, and generates the sender message display area according to the contents and type of the message. When the type of the message is simple text, the message is displayed directly. When the type of the message is a Uniform/Universal Resource Locator (URL) message, special effects, e.g. a special color and a under line are configure for the URL message and an address of the URL message is stored in the IM client, when the URL message is clicked, the website corresponding to the URL message is jumped to. When the type of the message is a topic message, e.g. micro-blog messages published by multiple users for a certain topic, special characters are added in front of and behind a key word of the topic, when the topic message is clicked, the website corresponding to the contents of the topic is jumped to. When the contents of the message include identification information of a guest, special effect or special color is configured, when the identification information is clicked, a guest page corresponding to the guest is triggered. When the contents of the message include multimedia information, e.g. picture information, audio information or video information, a preview effect picture of the multimedia information is displayed, and various operations can be performed for the multimedia information, e.g. a copy operation and an open operation.

When the independent message page includes the message source display area, the IM client obtains contents and type of a message source of the message according to the identification information of the message, and displays the contents and the type of the message source of the message in the message source display area. When the independent message page includes specific information display area, the IM client obtains sending time and a sending mode of the message according to the identification information of the message, and displays the sending time and sending mode of the message in the specific information display area. If the message is a forwarding message, the IM client obtains the times of forwarding the message and performs various operations for the message, e.g. a dialog operation, a forwarding operation, a copying operation and a reporting operation. If the message is published by the user via using the IM client, the operations can be performed also includes a cancelling operation. When the cancelling operation is performed, the source of the independent message page (e.g. the home page) is notified of that the message is cancelled the message, and the corresponding interface is updated. The identification information of the message may be the key value of the message.

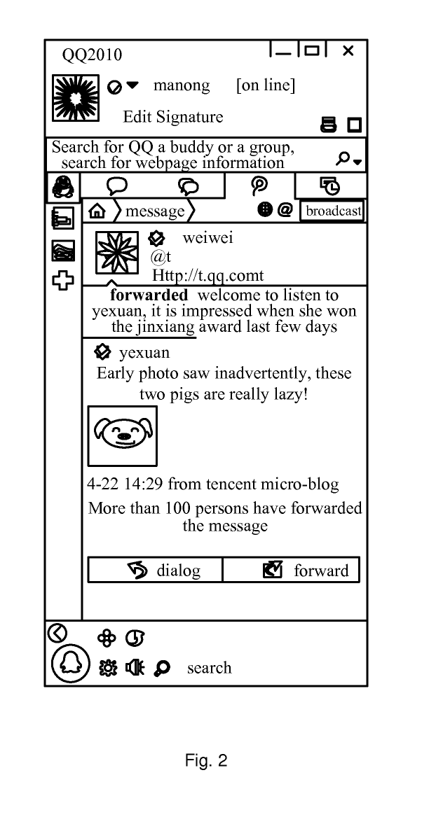

FIG. 2 is a schematic diagram illustrating an independent message page in an application scenario according to an embodiment of the present invention. A development environment of the effect diagram is ATL project of VS2005. The independent message page includes a sender information area, a sender message display area, a message source display area and a specific information display area, and also includes two buttons “dialog” and “forwarding” which are located at the bottom of the independent message page and displayed in the middle. The IM client monitors a sizechange event in the control layer. When the sizechange event happens, the IM client calculates the width of the whole panel, and reassigns the size of the two buttons, so that the sizes of the two button “dialog” and “forwarding” are automatically changes with the width of the panel.

Because the lengths of the micro-blog messages corresponding to different message bodies may be different, when different message bodies are triggered, all of the contents of the micro-blog message corresponding to different message bodies can not be displayed by the independent message page with the same size. Hence, when assignment is performed for content data of the independent message page, the size of the independent message page is calculated, and information, e.g. a location of a scroll bar is dynamically determined according to the size of the current main panel, e.g. the size of a user home page, so that when the contents of the micro-blog message are large, the user can check all of the contents of the micro-blog message by dragging the scroll bar. As shown in FIG. 2, below the head portrait area, i.e. the head portrait of weiwei, a sharp corner effect is displayed, and a whole background picture may be drawn by using a jiugong mode, and a gradient color effect may be used, so that the color of the whole message area is transit naturally.

In the embodiments of the present invention, the independent message page is established and displayed for the message according to the trigger event for the message in the main panel, and the entrance for the independent message page corresponding to the message in the main panel is provided, and thus the displayed contents of the message is greatly increased, and the usability and interactivity of the IM client are improved.

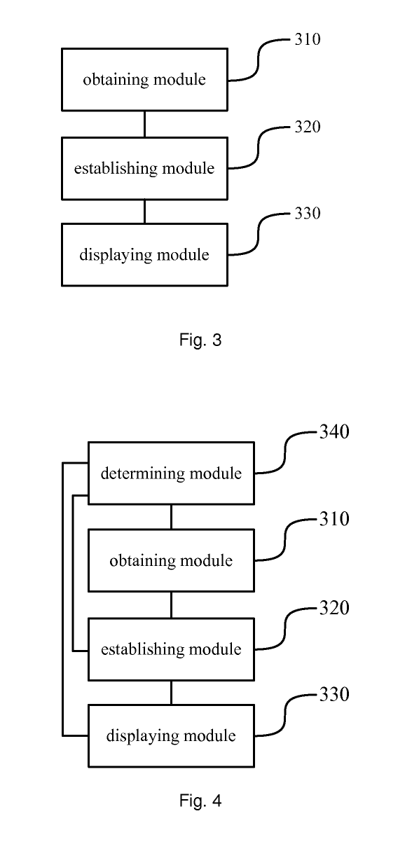

FIG. 3 is a schematic diagram illustrating an apparatus for establishing an independent message page according to an embodiment of the present invention. As shown in FIG. 3, the apparatus includes an obtaining module 310, an establishing module 320 and a displaying module 330.

The obtaining module 310 is adapted to obtain a trigger event for a message in a main panel, and obtain identification information of the message according to the trigger event.

The establishing module 320 is adapted to determine an independent message page corresponding to the identification information of the message obtained by the obtaining module 310.

The displaying module 330 is adapted to display the independent message page established by the establishing module 320.

The identification information of the message includes a key value of the message corresponding to the trigger event. The independent message page includes at least one of the following: a sender information area, a sender message display area, a message source display area and a specific information display area.

When the independent message page includes the sender information area, the establishing module 320 is adapted to obtain a UIN of a sender of the message from a message information center according to the identification information of the message, obtain a head portrait picture of the sender according to the UIN, and obtain authentication information of the sender from an authentication server; display the head portrait picture and the authentication information in the sender information area.

When the independent message page includes the sender message display area, the establishing module 320 is adapted to obtain contents and a type of the message according to the identification information of the message, and display the contents and the type of the message in the sender message display area.

When the independent message page includes the message source display area, the establishing module 320 is adapted to obtain contents and a type of a message source of the message according to the identification information of the message, and display the contents and the type of the message source in the message source display area.

When the independent message page includes specific information display area, the establishing module 320 is adapted to obtain sending time and a sending mode of the message according to the identification information of the message, and display the sending time and the sending mode of the message in the specific information display area. The identification information of the message may be the key value of the message.

Further, as shown in FIG. 4, the apparatus further includes a determining module 340.

The displaying module 330 is further adapted to display the independent message page when the determining module 340 determines that the independent message page corresponding to the identification information has been established. The establishing module 320 is further adapted to establish the independent message page corresponding to the identification when the determining module 340 determines that the independent message page corresponding to the identification information is not established.

The establishing module 320 includes a first unit and a second unit. The first unit is adapted to establish the independent message page when no independent message page is established, and contents of the independent message page correspond to the identification information; the second unit is adapted to update a established independent message page when the established independent message page does not correspond to the identification information, and contents of the updated independent message page correspond to the identification information.

In the embodiments of the present invention, the independent message page is established and displayed for the message according to the trigger event for the message in the main panel, and the entrance for the independent message page corresponding to the message in the main panel is provided, and thus the displayed contents of the message is greatly increased, and the usability and interactivity of the IM client are improved.

According to the above description of examples, it can be clearly understood by those skilled in the art that the present invention can be realized by software accompanying with necessary general hardware platforms, or by hardware. In many cases, the former is a preferred manner. Based on this, the essential part of the technical solution of the present invention or the part contributed to the prior art can be in the form of a software product, and the computer software product is stored in a storage medium and includes several codes to make a computer device (such as a handset, a personal computer, a server or a network device) perform the method in embodiments of the present invention.

The foregoing is only preferred examples of the present invention. Any modification, equivalent substitution and improvement without departing from the spirit and principle of the present invention are within the protection scope of the present invention.

Persons having ordinary skill in the art may understand that the modules in the device embodiment may be distributed in the device of the embodiment according to embodiment descriptions, or may change correspondingly to locate in one or more devices different from the embodiment. The modules in above embodiment may be merged into one module, or may be divided into multiple sub-modules furthermore.

Sequence number in above embodiments of the present invention is only used for descriptions, which doesn't demonstrate good or better embodiment.

The foregoing is only detailed examples of the present invention and is not used to limit the protection scope of the present invention. Any modification, equivalent substitution and improvement are within the protection scope of the present invention.

1. A method for establishing an independent message page, comprising:
obtaining, by an IM client, a trigger event for a message in a main panel, and obtaining identification information of the message according to the trigger event;
determining, by the IM client, an independent message page corresponding to the identification information of the message;
displaying, by the IM client, the independent message page.

2. The method of claim 1, wherein the independent message page comprises at least one of: a sender information area, a sender message display area, a message source display area and a specific information display area.

3. The method of claim 2, wherein when the independent message page comprises the sender information area,
determining, by the IM client, an independent message page corresponding to the identification information of the message comprises:
obtaining, by the IM client, a User Identification Number (UIN) of a sender of the message, according to the identification information of the message,
obtaining, by the IM client, a head portrait picture of the sender according to the UIN, and obtaining authentication information of the sender;
displaying, by the IM client, the head portrait picture and the authentication information in the sender information display area.

4. The method of claim 2, wherein when the independent message page comprises the sender message display area,
determining, by the IM client, an independent message page corresponding to the identification information of the message comprises:
obtaining, by the IM client, contents and a type of the message according to the identification information of the message, and displaying the contents and the type of the message in the sender message display area.

5. The method of claim 2, wherein when the independent message page comprises the message source display area,
determining, by the IM client, an independent message page corresponding to the identification information of the message comprises:
obtaining, by the IM client, contents and a type of a message source of the message according to the identification information of the message, and displaying the contents and the type of the message source in the message source display area.

6. The method of claim 2, wherein when the independent message page comprises a specific information display area;
determining, by the IM client, an independent message page corresponding to the identification information of the message comprises:
obtaining, by the IM client, sending time and a sending mode of the message according to the identification information of the message, and displaying the sending time and the sending mode of the message in the specific information display area.

7. The method of claim 1, wherein determining, by the IM client, an independent message page corresponding to the identification information of the message comprises:
determining, by the IM client, whether the independent message page corresponding to the identification information has been established according to the identification information;
establishing, by the IM client, the independent message page corresponding to the identification when the independent message page corresponding to the identification information is not established.

8. The method of claim 7, wherein establishing, by the IM client, the independent message page corresponding to the identification comprises:
establishing the independent message page when no independent message page is established, and contents of the independent message page corresponding to the identification information;
updating an established independent message page when the established independent message page does not correspond to the identification information, and contents of the established independent message page updated corresponding to the identification information.

9. The method of claim 1, wherein the identification information of the message is a key value of the message.

10. An apparatus for establishing an independent message page, comprising a processor coupled to a memory storing instructions for execution by the processor, and further comprising:
an obtaining module, adapted to obtain a trigger event for a message in a main panel, and obtain identification information of the message according to the trigger event;
an establishing module, adapted to determine an independent message page corresponding to the identification information of the message obtained by the obtaining module;
a displaying module, adapted to display the independent message page established by the establishing module.

11. The apparatus of claim 10, wherein
the establishing module is adapted to, when the independent message page comprises a sender information area, obtain a UIN of a sender of the message according to the identification information of the message; obtain a head portrait picture of the sender according to the UIN, and obtain authentication information of the sender; display the head portrait picture and the authentication information in the sender information area.

12. The apparatus of claim 10, wherein
the establishing module is adapted to, when the independent message page comprises a sender message display area, obtain contents and a type of the message according to the identification information of the message, and display the contents and the type of the message in the sender message display area.

13. The apparatus of claim 10, wherein
the establishing module is adapted to, when the independent message page comprises a message source display area, obtain contents and a type of a message source of the message according to the identification information of the message, and display the contents and the type of the message source in the message source display area.

14. The apparatus of claim 10, wherein
the establishing module is adapted to, when the independent message page comprises a specific information display area, obtain sending time and a sending mode of the message according to the identification information of the message, and display the sending time and the sending mode of the message in the specific information display area.

15. The apparatus of claim 10, further comprising:
a determining module, adapted to determine whether the independent message page corresponding to the identification information has been established according to the identification information; wherein
the establishing module is adapted to establish the independent message page corresponding to the identification when the independent message page corresponding to the identification information is not established.

16. The apparatus of claim 15, wherein the establishing module comprises:
a first unit, adapted to establish the independent message page when no independent message page is established, and contents of the independent message page corresponding to the identification information;
a second unit, adapted to update an established independent message page when the established independent message page does not correspond to the identification information, and contents of the established independent message page updated corresponding to the identification information.

17. A non-transitory computer readable storage medium, storing one or more programs, the one or more programs comprising instructions, which when executed by a computer device, causes the computer device to perform the method claimed in claim 1.
